(19) United States
(12) Patent Application Publication
(10) Pub. No.: US 2006/0124367 A1
(43) Pub. Date: Jun. 15, 2006

(54) Method for operating an electrically driven motor vehicle and device therefor

(75) Inventors: Martin Georgii, Suttgart (DE); Axel Krause, Nesslau (CH)

Correspondence Address: CROWELL & MORING LLP;INTELLECTUAL PROPERTY GROUP, P.O. BOX 14300, WASHINGTON, DC, 20044-4300, US

(73) Assignee: DAIMLCHRYSLER AG, STUTTGART (DE)

(21) Appl. No.: 10/515,596

(22) PCT Filed: Mar. 26, 2003
(86) PCT No.: PCT/EP03/03116

§ 371 Date: Sep. 7, 2005

(30) Foreign Application Priority Data
May 28, 2002 (DE) 102 23 672.0

(51) Int. Cl. B60L 11/18; H01M 8/04

(52) U.S. Cl. 180/65.3; 429/24; 429/23

(57) ABSTRACT

The invention relates to a method and a device for a motor vehicle having a current/voltage supply unit, in particular a fuel cell unit and/or a battery, with the current/voltage supply unit being necessarily discharged, when it is switched off, through a control and/or distribution unit or a temperature-dependent resistor.

### BACKGROUND AND SUMMARY OF THE INVENTION

This application claims the priority of German patent document 102 23 672.0, filed 28 May 2002 (PCT International Application No.: PCT/EP03/03116, filed 26 Mar. 2003), the disclosure of which is expressly incorporated by reference herein.

The invention relates to a method and apparatus for operating an electrically driven motor vehicle.

In a fuel cell system, electrical energy is produced from a gaseous fuel (normally hydrogen), and an oxygen-rich gas. When the fuel cell system is switched off, fuel and oxygen-rich gas are frequently still present in the fuel cell unit and in the supply lines, and electrical energy is produced which is no longer consumed. If the fuel cell unit remains subject to the high voltage that is produced, this can lead to damage to the fuel cell system and to a hazard to maintenance personnel (for example during inspections and/or repairs). Similar safety-relevant problems are known from the use of batteries.

U.S. Pat. No. 5,023,150 discloses a method and apparatus for operating a fuel cell system in which a switching element that is normally closed can be driven via a controller to connect a fuel cell unit to a parallel connected discharge resistor, to discharge the fuel cell after it is being switched off.

One object of the present invention is to provide an easily implemented method for safe operation of an electrically driven motor vehicle when and after a current/voltage supply unit is switched off.

A further object of the invention is to provide a device for carrying out the method according to the invention.

These and other objects and advantages are achieved by the method and apparatus according to the invention, in which the switched-off current/voltage supply unit is advantageously discharged via components that are already present in the motor vehicle. This technique avoids packaging problems and additional component costs.

In one embodiment of the invention, the current/voltage supply unit is discharged via a temperature-dependent resistor, advantageously in the form of a self-controlling discharge. That is, the rate of discharge depends on the voltage of the current/voltage supply unit, and increases as the voltage falls.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a current/voltage supply unit with a connected circuit; and

FIG. 2 is a schematic illustration of a current/voltage supply unit with a discharge circuit.

### DETAILED DESCRIPTION OF THE INVENTION

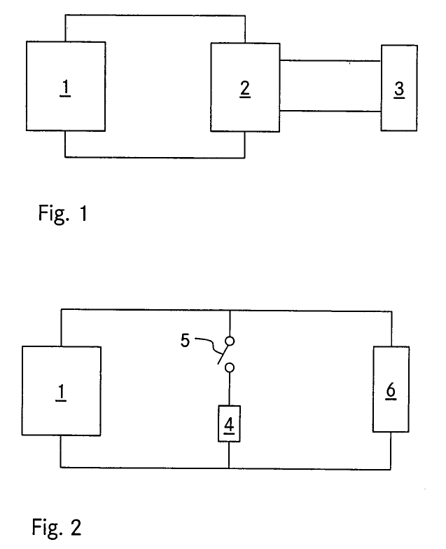

FIG. 1 is a schematic illustration of a current/voltage supply unit 1 (preferably a fuel cell unit and/or a battery) with a connected circuit that is not identified in any greater detail. A control and/or distribution unit 2 which is normally connected to the current/voltage supply unit 1 distributes the electrical energy that is produced to further electrical assemblies represented by the load 3. The control and/or distribution unit 2 normally contains an internal current/voltage supply 2A that is fed from the current/voltage supply unit 1, and a DC/DC voltage converter (not illustrated) that converts the voltage that is produced by the current/voltage supply unit 1 to the level of the operating voltage for the load 3. The control and/or distribution unit 2 distributes electrical energy to, for example, measurement circuits connected to the control and/or distribution unit 2. The internal current/voltage supply 2A supplies electrical energy in particular to microcontroller systems which are inherent to the control and/or distribution unit 2, driver circuits, converters and/or other circuits which are inherent to the control and/or distribution unit. Preferably, the internal current/voltage supply 2A also has a converter, such as a DC/DC voltage converter (not illustrated). The internal voltage level in the control and/or distribution unit 2 is preferably lower than the voltage level of the current/voltage supply unit 1. Furthermore, an electrical traction motor (not illustrated) and/or a vehicle power supply system may be connected to the control and distribution unit 2 as the load 3.

When or after the current/voltage supply unit 1 is switched off, the voltage that is still present across the current/voltage supply unit 1 must be reduced in order to prevent degradation of the current/voltage supply unit 1, and to ensure protection against direct contact. Since the internal voltage supply 2A for the control and/or distribution unit 2 is provided via the current/voltage supply unit 1, the internal voltage supply 2A is still supplied with electrical energy even after the current/voltage supply unit 1 has been switched off. This condition continues until the current/voltage supply unit 1 (or the capacitances in the supply circuit upstream thereof, which are not identified in any greater detail) is discharged to a lower limit value. The current/voltage supply unit 1 is thus necessarily discharged via the control and/or distribution unit 2 and its internal current/voltage supply 2A and the loads which are connected to it, such as a microcontroller and measurement circuits. The internal current/voltage supply and/or the loads which are connected to it are in this case advantageously designed such that the current/voltage supply unit is discharged to below 50 V within 60 seconds.

Advantageously, no additional components or parts are required for the discharge process, since discharging takes place via a control and/or distribution unit 2 which already exists in a motor vehicle. No additional space is therefore required. Since no specific discharge device is used, there is advantageously no additional power loss.

The control and/or distribution unit 2 may be designed so that it can be supplied with electrical energy from a plurality of current/voltage supply units 1. It is thus possible to provide a supply from a vehicle battery and from a fuel cell unit. The supply may be provided in parallel or in series form by the various current and/or voltage sources.

If a fuel cell unit is used as the current/voltage supply unit 1, then a measurement circuit with hydrogen sensors is normally provided to monitor the hydrogen concentration. The measurement circuit is normally connected to the fuel cell unit via an internal current or voltage supply of a control and/or distribution unit 2. Since hydrogen is an easily flammable gas, it is worthwhile to monitor the hydrogen concentration even when the fuel cell unit is switched off, for example when the vehicle is parked. When and after the fuel cell unit is switched off, the measurement circuit and the hydrogen sensors can preferably be supplied with the discharge current of the fuel cell unit via the internal current or voltage supply for the control and/or distribution unit.

FIG. 2 shows a schematic illustration of a current/voltage supply unit 1 with a further preferred embodiment of a discharge circuit. When or after the current/voltage supply unit 1 is switched off, the discharge process takes place via a temperature-dependent resistor 4. A switching element 5 may be connected in series with the temperature-dependent resistor 4. When the switching element 5 is closed, the temperature-dependent resistor 4 is connected in parallel with the current/voltage supply unit 1, and is discharged. The switching element 5 can preferably be supplied with electric current by means of the discharge current.

The temperature-dependent resistor 4, preferably a PTC thermistor or a PTC element with a positive temperature coefficient, has a low resistance at low temperatures, and a high resistance at high temperatures. Preferably, it is designed such that it consumes only a small amount of electrical power in the normal operating voltage range of the current/voltage supply unit 1. (The normal operating voltage range of a fuel cell unit is usually between 250 V and 450 V; however, fuel cell units with different operating voltage ranges can be used.) The preferably relatively high operating voltage of the current/voltage supply unit 1 means that the temperature of the resistor 4 is relatively high during operation of the current/voltage supply unit 1, and its resistance is thus likewise correspondingly high. As a result, there is no need for the switching element 5, since the high resistance of the resistor 4 during operation of the current/voltage supply unit corresponds, in terms of its function, to an open switching element 5. When the current/voltage supply unit 1 is switched off, the voltage falls slowly, the temperature of the resistor 4 falls, and its resistance thus likewise falls, so that the rate of discharge increases. The temperature-dependent resistor is advantageously of such a magnitude that the applied voltage falls to below 50 V within 60 seconds after switching off the current/voltage supply unit 1.

PTC elements may be used for protection of batteries since they act in a self-regulating manner to protect the battery against excessive temperatures and discharge currents (U.S. Pat. No. 4,255,698).

Loads 6 (for example, an electrical traction motor and a vehicle power supply system) may be connected in parallel with the current/voltage supply unit 1 via lines which are not identified in any more detail.

If a fuel cell unit is used as the current/voltage supply unit 1, then the switching element 5 is preferably opened again only when the amount of oxidants or oxygen-rich gas which is present in the fuel cell unit and in the supply lines has fallen below a lower limit value. The discharge process prevents any danger from the fuel cell system and, in particular, loading heating of the catalytic burner, which is normally connected downstream from the fuel cell unit, as a result of oxidation taking place after switch-off.

The switching element 5 or the temperature-dependent resistor is advantageously connected to ground via a switching element (not illustrated), for example to the vehicle bodywork. Repairs and inspections can thus be carried out safely.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A method for operating an electrically driven motor vehicle having a current/voltage supply unit, wherein:
electrical energy which is present when the current/voltage supply unit is switched off is consumed by one of (i) a control and/or distribution unit of the motor vehicle, and an electrical circuit which is associated with said control and/or distribution unit, and (ii) a temperature-dependent resistor; and
said consuming is continued until at least one lower voltage limit is undershot.

12. The method as claimed in claim 11, wherein said electrical energy is consumed by an internal current/voltage supply of the control and/or distribution unit.

13. The method as claimed in claim 11, wherein said electrical energy is consumed by a measurement circuit of the control and/or distribution unit.

14. The method as claimed in claim 13, wherein the measurement circuit determines a hydrogen concentration.

15. The method as claimed in claim 11, wherein the resistance of the temperature-dependent resistor decreases as the applied voltage falls and as the temperature falls.

16. The method as claimed in claim 11, wherein the current/voltage supply unit comprises a battery.

17. The method as claimed in claim 11, wherein the current/voltage supply unit comprises a fuel cell unit.

18. Electrical energy supply apparatus for a motor vehicle, comprising:
a first current/voltage supply unit; and
means for discharging electrical energy which remains at an output of said first current/voltage supply unit, until a voltage at said output falls below a preset value;
wherein said means for discharging comprises a temperature dependent resistor coupled to said output of said first current/voltage supply unit.

19. The device as claimed in claim 18, wherein a series circuit comprising a switching element and the temperature-dependent resistor is connected in parallel with said output of the current/voltage supply unit.

20. The device as claimed in claim 18, wherein the temperature-dependent resistor is a PTC thermistor.

21. Electrical energy supply apparatus for a motor vehicle, comprising:
a first current/voltage supply unit; and
means for discharging electrical energy which remains at an output of said first current/voltage supply unit, until a voltage at said output falls below a preset value;
wherein said means for discharging comprises circuit components associated with a control and/or distribution unit of said motor vehicle.

22. The apparatus according to claim 21, wherein said circuit components comprise an internal current/voltage supply of said control and/or distribution unit, which internal current/voltage supply unit is coupled to said output of said first current/voltage supply unit.

23. The apparatus according to claim 22, wherein said circuit components comprise load elements connected to said control and/or distribution unit.
